(19) United States
(12) Patent Application Publication
(10) Pub. No.: US 2026/0162962 A1
(43) Pub. Date: Jun. 11, 2026

(54) METHOD FOR STABILIZING BATTERY IN FORMATION PROCESS AND BATTERY FORMATION PROCESS SYSTEM

(71) Applicant: SK ON CO., LTD., Seoul (KR)

(72) Inventors: Seung Hoon JUNG, Daejeon (KR); Kyung Hee JEONG, Daejeon (KR); Woo Seop KIM, Daejeon (KR); Kwae Ha KIM, Daejeon (KR); Du Yeon LEE, Daejeon (KR); Joo Eun LEE, Daejeon (KR); Seon Hui CHOI, Daejeon (KR)

(21) Appl. No.: 19/405,398

(22) Filed: Dec. 2, 2025

(30) Foreign Application Priority Data
Dec. 5, 2024 (KR) 10-2024-0179303

(51) Int. Cl. H01M 4/04; H02J 7/00; H02J 7/90

(52) U.S. Cl. CPC H01M 4/0447; H02J 7/875; H02J 7/927

(57) ABSTRACT

A method of stabilizing a battery in a formation process includes a charge-discharge operation of charging or discharging a battery cell in a formation process, and a pulse operation of charging or discharging the battery cell with a pulse current having a greater fluctuation than a current of the charge-discharge operation after the charge-discharge operation.

### CROSS-REFERENCE TO RELATED APPLICATION(S)

This patent document claims the priority and benefits of Korean Patent Application No. 10-2024-0179303 filed on Dec. 5, 2024, the disclosure of which is incorporated herein by reference in its entirety.

### TECHNICAL FIELD

The disclosure and implementations disclosed in this patent document generally relate to a method for stabilizing a battery in a formation process and a battery formation process system.

### BACKGROUND

In the battery field, secondary batteries, unlike primary batteries, offer the convenience of being rechargeable and dischargeable, and are thus attracting considerable attention as a power source for various mobile devices and electric vehicles, and the like. These secondary batteries may include battery cells, each of which includes an electrode assembly formed by stacking a cathode plate, an anode plate, and a separator or which is provided by winding the electrode assembly into a roll, housed within a case. Multiple battery cells may be stacked in a predetermined direction and housed in a battery module or battery pack. A battery pack may include multiple battery modules.

### SUMMARY

Batteries may be widely applied to devices within green technology fields such as electric vehicles, battery charging stations, energy storage systems (ESS), and other battery-based applications such as photovoltaics and wind power, and may also be used in eco-friendly mobility devices and the like, including electric vehicles and hybrid vehicles, to prevent climate change by reducing air pollution and greenhouse gas emissions.

The present disclosure can be implemented in some embodiments to provide a method of stabilizing a battery in a formation process and a battery formation process system in which the total required time for a formation process (for example, to less than one day) may be shortened and the overall productivity of battery processes, including the formation process, may be improved. For example, the time required for battery cells to be left in a typical formation process (for example, several days) may be omitted or reduced.

In some embodiments of the present disclosure, a method of stabilizing a battery in a formation process includes a charge-discharge operation of charging or discharging a battery cell in a formation process; and a pulse operation of charging or discharging the battery cell with a pulse current having a greater fluctuation than a current of the charge-discharge operation after the charge-discharge operation.

In an example, the charge-discharge operation may include a first charging operation of performing a press pre-charge (PPC) or a pre-charge on the battery cell; and a second charge-discharge operation of performing a formation charge or a formation charge-discharge on the battery cell after the first charging operation. The pulse operation may include charging or discharging with the pulse current during at least one of a period after the second charge-discharge operation and a period between the first charging operation and the second charge-discharge operation.

In an example, the second charge-discharge operation may include charging and discharging the battery cell, and the pulse operation may include charging with the pulse current.

In an example, the second charge-discharge operation may include charging, discharging, and recharging the battery cell, and the pulse operation may include discharging with the pulse current.

In an example, the method of stabilizing a battery in a formation process may further include an aging operation aging the battery cell, and the aging operation may include a first aging operation of aging the battery cell between the first charging operation and the second charge-discharge operation; and a second aging operation of aging the battery cell after the second charge-discharge operation. The pulse operation may include charging or discharging with the pulse current during at least one of a period between the first charging operation and the first aging operation and a period between the second charge-discharge operation and the second aging operation.

In an example, each of the first aging operation and the second aging operation may include high-temperature aging for aging the battery cell at a higher temperature than a temperature of the pulse operation; and low-temperature aging for aging the battery cell at a lower temperature than the high temperature.

In an example, a total aging time of each of the first aging operation and the second aging operation may be 1 minute or more and 10 minutes or less.

In an example, the method of stabilizing a battery in a formation process may further include a voltage measurement operation of measuring voltage of the battery cell from a time point between the second charge-discharge operation and the second aging operation to a time point after the second aging operation, and a defect detection operation of detecting a defect in the battery cell based on a difference between a pattern of the voltage measured in the voltage measurement operation and a reference pattern.

In an example, the method of stabilizing a battery in a formation process may further include an aging operation aging the battery cell after the pulse operation.

In an example, the method of stabilizing a battery in a formation process may further include a voltage measurement operation of measuring voltage of the battery cell from a time point between the pulse operation and the aging operation to a time point after the aging operation; and a defect detection operation of detecting a defect in the battery cell based on a difference between a pattern of the voltage measured in the voltage measurement operation and a reference pattern.

In an example, the pulse operation may include discharging the battery cell with the pulse current when the battery cell is in a charged state by the charge-discharge operation, and charging the battery cell with the pulse current when the battery cell is in a discharged state by the charge-discharge operation.

In an example, the charge-discharge operation may include charging the battery cell with a constant current having less fluctuation than the pulse current for at least a portion of time of the charge-discharge operation.

In an example, a current during a portion of a unit cycle of the pulse current may be greater than a current during the charge-discharge operation, and s total time for charging or discharging with the pulse current may be shorter than a total time for charging or discharging the battery cell during the charge-discharge operation.

In an example, the pulse operation may include charging or discharging with the pulse current at a charge/discharge rate (C-rate) of 0.5 C or more and 5.0 C or less for a total time of 1 second or more and 30 seconds or less.

In some embodiments of the present disclosure, a battery formation process system includes a charger-discharger configured to charge or discharge a battery cell to be subjected to a formation process; and a pulse generator configured to generate a pulse such that current of the battery cell is converted into a pulse current while the charger-discharger is charging or discharging the battery cell.

In an example, the battery formation process system may further include a measuring device configured to measure voltage of the battery cell from a time point after the pulse generator generates the pulse; and a controller configured to detect a defect in the battery cell based on a difference between a pattern of the voltage measured by the measuring device and a reference pattern.

In an example, the battery formation process system may further include a temperature controller configured to raise temperature of the battery cell during a portion of time while the measuring device measures the voltage of the battery cell, and the charger-discharger may stop charging or discharging the battery cell while the temperature controller raises the temperature.

In an example, the battery formation process system may further include a pressurizer applying pressure to the battery cell, the charger-discharger may pre-charge the battery cell while the pressurizer applies the pressure to the battery cell, and may perform a formation charge or a formation charge-discharge on the battery cell while the pressurizer is releasing pressure to the battery cell, the measuring device may measure voltage of the battery cell from a point in time after the formation charge or the formation charge-discharge on the battery cell, and the pulse generator may generate a pulse so that the current of the battery cell is converted into the pulse current while the charger-discharger performs at least one of pre-charge, the formation charge, or the formation charge-discharge on the battery cell.

In an example, the pulse generator may generate a pulse so that the battery cell is discharged with the pulse current while the charger-discharger charges the battery cell, or may generate a pulse so that the battery cell is charged with the pulse current while the charger-discharger discharges the battery cell.

In an example, a current during a portion of a unit cycle of the pulse current may be greater than the current of the battery cell before the pulse generator generates the pulse, a total time for which the pulse generator generates the pulse may be shorter than a total time for which the charger-discharger charges or discharges the battery cell while the pulse generator is not generating the pulse, and the pulse generator may generate a pulse so that the battery cell is charged or discharged with the pulse current at a charge/discharge rate (C-rate) of 0.5 C or more and 5.0 C or less for a total time of 1 second or more and 30 seconds or less.

### BRIEF DESCRIPTION OF DRAWINGS

Certain aspects, features, and advantages of the present disclosure are illustrated by the following detailed description with reference to the accompanying drawings.

FIGS. 1 and 2 are each a flowchart illustrating a method of stabilizing a battery in a formation process according to an embodiment.

FIG. 3 is a diagram illustrating a battery formation process system according to an embodiment.

FIG. 4 is a graph illustrating the voltage and temperature of a battery cell over time in a method of stabilizing a battery in a formation process and a battery formation process system according to an embodiment.

FIG. 5A is a graph illustrating discharging with a pulse current after a pre-charge in a method of stabilizing a battery in a formation process and a battery formation process system according to an embodiment.

FIG. 5B is a graph illustrating discharging with a pulse current after a formation charge-discharge in a method of stabilizing a battery in a formation process and a battery formation process system according to an embodiment.

FIG. 5C is a graph illustrating charging with a pulse current after formation charge-discharge of a method of stabilizing a battery in a formation process and a battery formation process system according to an embodiment.

FIG. 6 is a diagram illustrating a method of stabilizing a battery in a formation process and a battery formation process system according to an embodiment, in which polarization within a battery cell is resolved using pulse current.

FIGS. 7A and 7B are graphs illustrating that the battery stabilization time shortens as the charge/discharge rate (C-rate) of the pulse current increases in a method of stabilizing a battery in a formation process and a battery formation process system according to an embodiment.

### DETAILED DESCRIPTION

Features of the present disclosure disclosed in this patent document are described by example embodiments with reference to the accompanying drawings.

Before describing the embodiments in detail, it should be noted that the terms and words used in the following description and claims should not be construed as limited to their conventional or dictionary meanings. Based on the principle that inventors may appropriately define the concepts of terms to best describe their inventions, the terms and words should be interpreted with meanings and concepts consistent with the technical spirit of the present disclosure.

Identical reference numbers or symbols in respective drawings represent components or elements that perform substantially the same functions. For convenience of explanation and understanding, the same reference numbers or symbols may be used in different embodiments.

In the following description, singular expressions include plural expressions unless the context clearly indicates otherwise. Terms such as “include,” “configure,” and the like are intended to indicate the presence of features, numbers, steps, operations, components, parts, or combinations thereof described in the specification, but should be understood not to preclude the presence or addition of one or more other features, numbers, steps, operations, components, parts, or combinations thereof.

Furthermore, in the following description, terms such as “top,” “upper,” “lower side,” “lower,” “side,” “front,” “rear,” and the like are expressed based on the directions depicted in the drawings, and it is noted in advance that they may be expressed differently if the direction of the corresponding object changes.

Furthermore, terms including ordinal numbers, such as “first,” “second,” etc., may be used to distinguish between components in the following description and claims. These ordinal numbers are used to distinguish identical or similar components from each other, and the use of these ordinal numbers should not be interpreted in a limited manner. For example, components associated with these ordinal numbers should not be interpreted in a restricted manner, such as in the order of use or disposition, based on their numbers. If necessary, respective ordinal numbers may be used interchangeably.

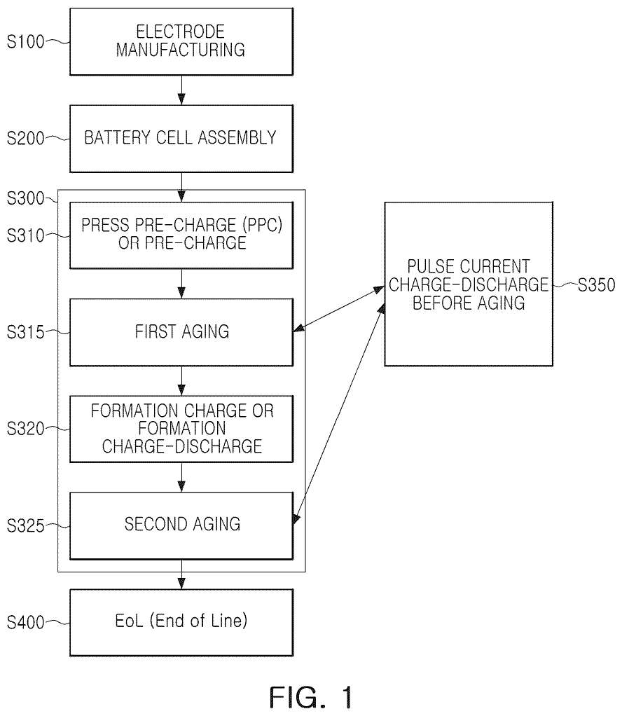

Referring to FIGS. 1 and 2, a formation process (S300) of a method of stabilizing a battery in a formation process and a battery formation process system according to an embodiment may be one of the sequentially performed battery processes (S100, S200, S300 and S400). The battery processes may include an electrode manufacturing process (S100), a battery cell assembly process (S200), the formation process (S300), and an End of Line (EoL) process (S400). The End of Line (EoL) process may be a post-battery process.

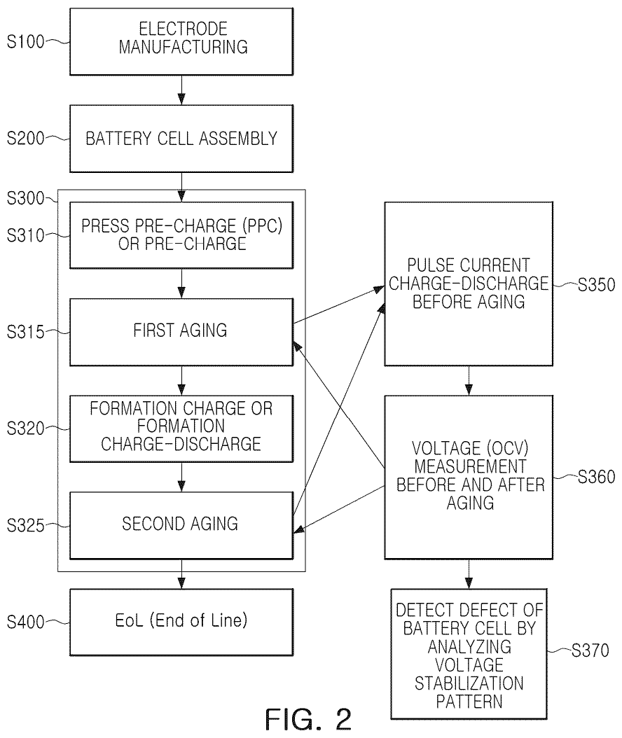

The electrode manufacturing process (S100) may include an operation of manufacturing battery electrodes (14 of FIG. 3) of at least one battery cell (10 of FIG. 3). For example, the electrode manufacturing process (S100) may include an operation of forming a slurry by mixing an active material, a conductive agent, a binder, and a solvent, an operation of coating the slurry on both sides of a cathode plate (for example, an aluminum plate, a copper plate), an operation of rolling the coated cathode plate, an operation of forming electrodes by slitting the coated and rolled cathode plate, an operation of vacuum-drying the electrodes, and an operation of notching the dried electrodes to manufacture battery electrodes (14 in FIG. 3).

The battery cell assembly process (S200) may include, prior to the formation process (S300), an operation of combining a battery case (12 in FIG. 3) and battery electrodes (14 in FIG. 3) and injecting an electrolyte into the battery case (12 in FIG. 3) to manufacture a battery cell (10 in FIG. 3). This operation may be included in the method of stabilizing a battery in a formation process according to an embodiment.

For example, the battery cell assembly process (S200) may include an operation of assembling tab-shaped battery electrodes (14 in FIG. 3) and a separator (for example, a porous polymer film or a porous non-woven fabric) according to a specific method, for example, at least one of winding, stacking, Jelly Roll, Z-folding type, and stack-folding, an operation of welding tab-shaped battery electrodes (14 in FIG. 3) to connect cathodes or anodes, and an operation of disposing the welded battery electrodes (14 in FIG. 3) in a battery case (12 in FIG. 3) and injecting an electrolyte into the battery case (12 in FIG. 3). The battery case (12 in FIG. 3) may be a pouch-shaped case including a sealing portion, but may also be implemented as a cylindrical case or a prismatic case depending on the design.

The formation process (S300) may include charging at least one battery cell (10 in FIG. 3) assembled through the battery cell assembly process (S200) so that the at least one battery cell (10 in FIG. 3) has electrical characteristics. At this time, a solid electrolyte interphase layer may be formed on the anode surface of the battery electrodes (14 in FIG. 3). Therefore, at least one battery cell (10 in FIG. 3) may have a microscopic structure capable of continuously undergoing an electrochemical reaction depending on the voltage of the battery electrodes (14 in FIG. 3).

For example, between the formation process (S300) and the end-of-line (EoL) process (S400), multiple battery cells (10 in FIG. 3) may be stacked and assembled into a single battery module. For example, multiple battery modules may be assembled into a single battery pack or a single battery rack.

The end-of-line (EoL) process (S400) may include an inspection operation of at least one battery cell having electrical characteristics after the formation process (S300). For example, the inspection may include at least one of the electrical performance (for example, capacity, charge/discharge voltage/current, internal resistance, insulation resistance) inspection of at least one battery cell, temperature sensor performance inspection, battery management system (BMS) performance inspection, and battery cell appearance inspection. Batteries that have completed the end-of-line (EoL) process (S400) may be shipped for use in eco-friendly vehicles such as electric vehicles or for use in energy storage systems.

During the formation process (S300), the interior of the battery cell (10 in FIG. 3) may temporarily become polarized during the charging process, which has electrical properties. Alternatively, during the formation process (S300), the battery cell (10 in FIG. 3) prior to stabilization may exhibit surface charge imbalance. Typically, the polarization and/or surface charge imbalance of the battery cell (10 in FIG. 3) may be gradually resolved by leaving the battery cell (10 in FIG. 3) for a long period of time (e.g., several days). However, leaving the battery cell for such an extended period of time (e.g., several days) may limit the reduction in the total required period of the formation process and may cause a decrease in the overall productivity of the battery process.

Referring to FIGS. 1 and 2, a method of stabilizing a battery in a formation process according to an embodiment may include a charge-discharge operation (S310 and/or S320) for charging or discharging a battery cell (10 of FIG. 3) in the formation process (S300), and may include a pulse operation (S350) for charging or discharging the battery cell (10 of FIG. 3) with a pulse current having a greater fluctuation than the current of the charge-discharge operation (S310 and/or S320) after the charge-discharge operation (S310 and/or S320). Charge-discharge(charge/discharge) refers to charging and/or discharging.

The pulse current of the pulse operation (S350), which fluctuates more than the current of the charge-discharge operation (S310 and/or S320), may more quickly resolve the polarization state and/or surface charge imbalance of the battery cell (10 in FIG. 3) prior to stabilization, and promote voltage (OCV) stabilization of the battery cell (10 in FIG. 3). Therefore, the total required time (for example, less than one day) for the formation process (S300) may be shortened, and the overall productivity of battery processes, including the formation process (S300), may be improved. For example, the time (e.g., several days) that battery cells are left in during a typical formation process may be omitted or reduced.

The current fluctuation may be defined as a value obtained by integrating a difference value between the current at each point in time during a unit cycle and the average current during the unit cycle, over the unit cycle. For example, the charge-discharge operation (S310 and/or S320) may include charging the battery cell (10 in FIG. 3) with a constant current that fluctuates less than the pulse current during at least a portion of the time of the charge-discharge operation (S310 and/or S320). The constant current may fluctuate less than the pulse current because the difference between the current at each point in time during a unit cycle and the average current during the unit cycle is always substantially zero. However, the current of the charge-discharge operation (S310 and/or S320) is not limited to a constant current. For example, the current of the charge-discharge operation (S310 and/or S320) may be a pulse current with less fluctuation, and the pulse current with less fluctuation may have an integrated value that is smaller than the integrated value of the pulse current of the pulse operation (S350).

The current waveform during a unit cycle of the pulse current may be substantially a square waveform, and the current waveform during multiple cycles of the pulse current may be substantially a sawtooth shape. During a portion of the unit cycle of the pulse current and the remaining portion, the current may be high and the current may be low (including 0 A), respectively. For example, since the duty ratio of the pulse current may be 50%, the portion of the period and the remaining period may have the same time length, but the present disclosure is not limited thereto.

Referring to FIGS. 1 and 2, a method of stabilizing a battery in a formation process according to an embodiment may further include an aging operation (S315 and/or S325) for aging the battery cell (10 of FIG. 3) after the pulse operation (S350). The aging may be the process of stopping charging and discharging the battery cell (10 of FIG. 3) and providing electrical rest to the battery cell (10 of FIG. 3). The battery cell (10 in FIG. 3) electrically stimulated by the pulse current of the pulse operation (S350) may be stabilized (for example, polarization relief, surface charge imbalance relief) relatively more quickly in the aging operation (S315 and/or S325). For example, the total aging time of the aging operation (S315 and/or S325) may be as short as 1 minute or more and 10 minutes or less. Accordingly, the time (for example, several days) for leaving the battery cell in the general formation process may be omitted or reduced.

Referring to FIG. 2, a method of stabilizing a battery in a formation process according to an embodiment may include a voltage measurement operation (S360) of measuring the voltage (Open Circuit Voltage, OCV) of a battery cell (10 of FIG. 3) from a time point between the pulse operation (S350) and the aging operation (S315 and/or S325) to a time point after the aging operation (S315 and/or S325), and may further include a defect detection operation (S370) of detecting a defect (for example, low voltage defect) of the battery cell (10 of FIG. 3) based on a difference between a pattern of voltage measured in the voltage measurement operation (S360) and a reference pattern.

For example, a battery cell (10 in FIG. 3) having a defect may have foreign matter or pinholes within the battery cell (10 in FIG. 3), and the foreign matter or pinholes in the battery cell (10 in FIG. 3) may be a factor in causing a low voltage failure of the battery cell (10 in FIG. 3). Depending on the low-voltage defect factor, the chemical/physical composition of the battery cell (10 in FIG. 3) may vary, and the internal resistance and equivalent circuit resistance of the battery cell (10 in FIG. 3) may also vary. Therefore, the voltage pattern after the pulse operation (S350) may vary depending on the presence or absence of a defect in the battery cell (10 in FIG. 3).

For example, the reference pattern may be voltage data (for example, nominal voltage data) and its characteristics (for example, slope, average value, deviation, or the like), measured in advance at multiple points in time from a time point before aging to a time point after aging of a non-defective battery cell. For example, in the defect detection operation (S370), characteristics (for example, slope, average, deviation, or the like) may be calculated from the voltage data of voltage measured in the voltage measurement operation (S360). If the difference between the calculated characteristics and the characteristics of the reference pattern exceeds the error range, information indicating a defect in the corresponding battery cell is generated. If the difference between the calculated characteristics and the characteristics of the reference pattern is within the error range, information indicating that the corresponding battery cell is not defective may be generated.

In this way, the method of stabilizing a battery in a formation process according to an embodiment not only shortens the total required time (for example, less than one day) for the formation process (S300), but also provides data capable of detecting defects in the battery cell (10 in FIG. 3). Therefore, the process of leaving the battery cell in a formation process for an extended period (for example, several days) to detect defects in the battery cell (10 in FIG. 3) may be omitted.

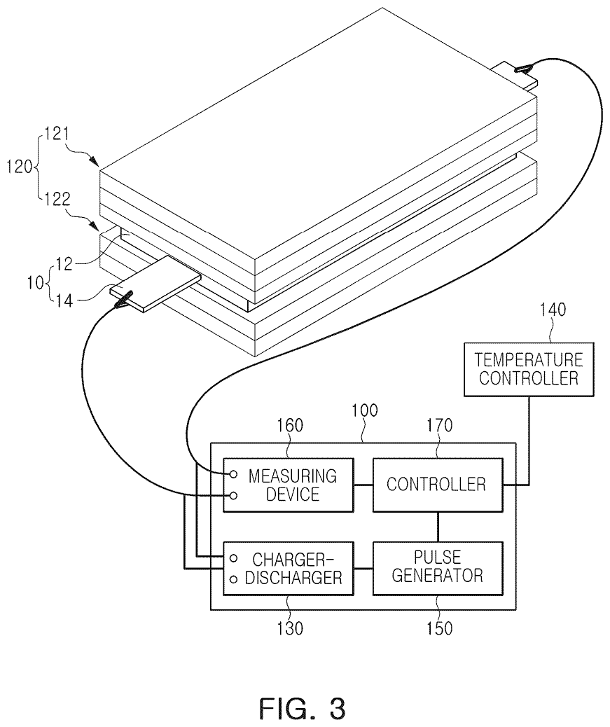

Referring to FIGS. 1, 2, and 4, the charge-discharge operation (S310 and/or S320) may include a first charging operation (S310) that performs a Press Pre-Charge (PPC) or pre-charge (see FIG. 4) on the battery cell (10 in FIG. 3), and may include a second charge-discharge operation (S320) that performs a formation charge or formation charge-discharge (100% Charge & Discharge in FIG. 4) on the battery cell (10 in FIG. 3) after the first charging operation (S310). The Press Pre-Charge (PPC) means that both pressurization and charging of the battery cell (10 in FIG. 3) are performed simultaneously.

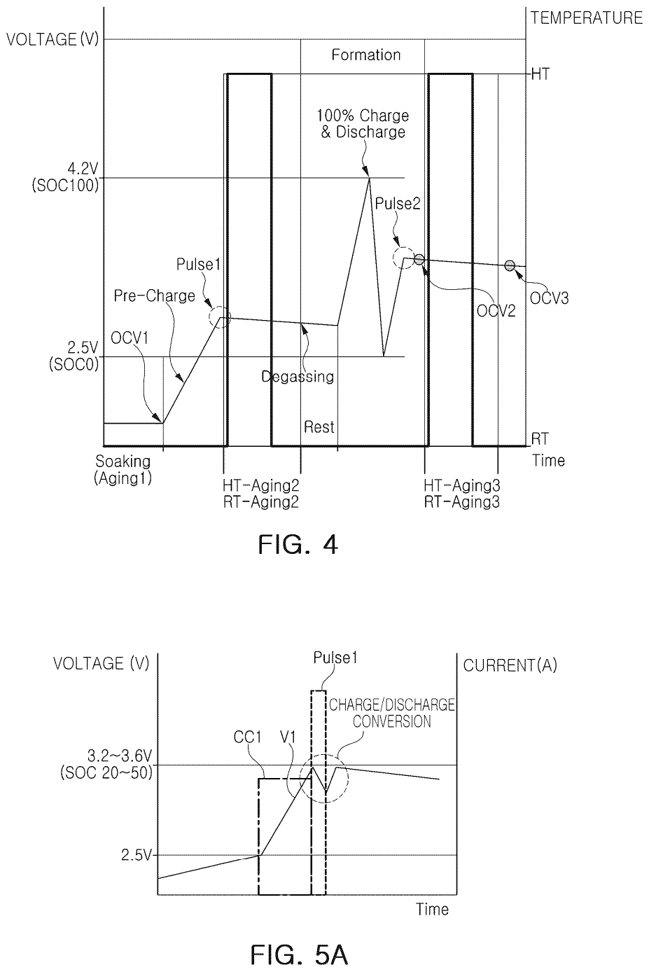

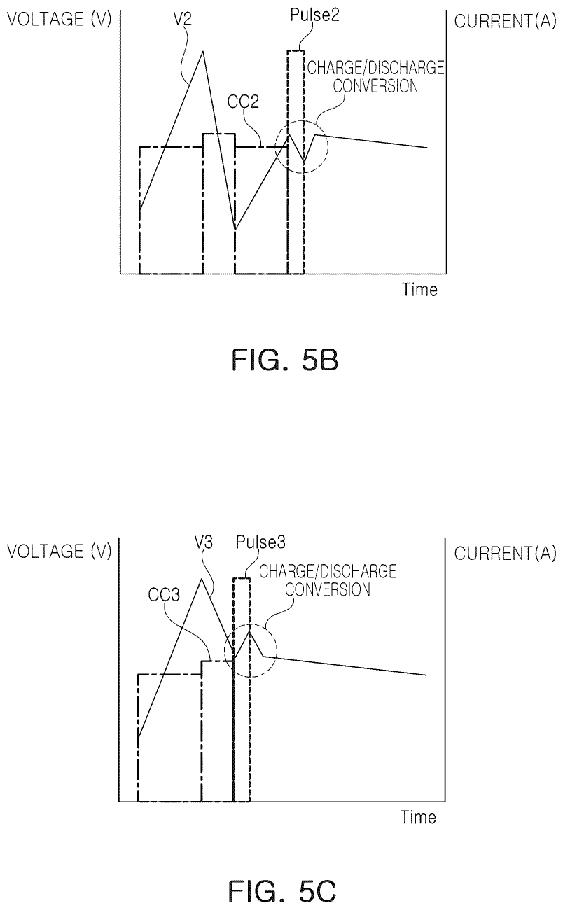

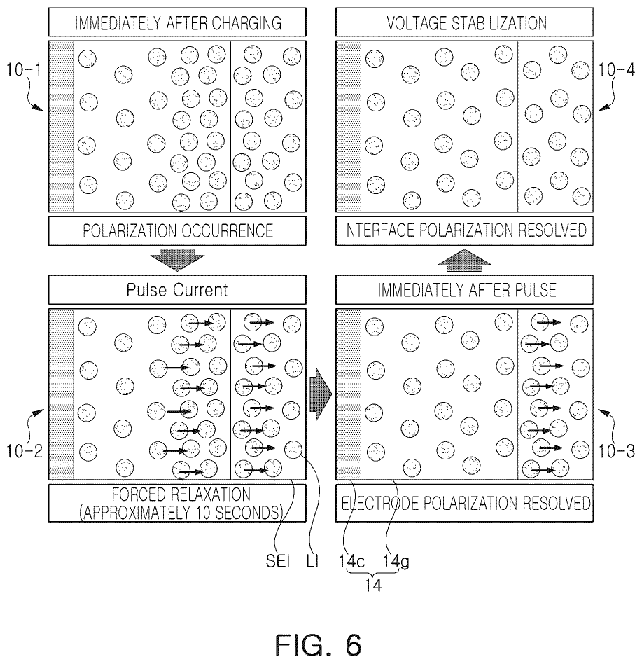

The first charging operation (S310) may include initially charging the battery cell (10 in FIG. 3) to a predetermined capacity (for example, 20% to 50%) (SOC 20 to 50 in FIG. 5A) after the battery cell (10 in FIG. 3) has been assembled. At this time, the inside of the battery cell (10 in FIG. 3) may gradually harden. For example, the battery cell (10 in FIG. 3) immediately after the battery cell assembly process (S200) may undergo a soaking process (Soaking, Aging1), and thereafter, the charger-discharger (130 in FIG. 3) may charge the battery cell (10 in FIG. 3) in a constant current mode, and the voltage (V1 in FIG. 5A) of the battery cell (10 in FIG. 3) may gradually increase as the battery cell is charged. Depending on the design, the measuring device (160 in FIG. 3) may measure the voltage (OCV1) of the battery cell (10 in FIG. 3).

For example, in the second charge-discharge operation (S320), the charger-discharger (130 in FIG. 3) may charge the battery cell (10 in FIG. 3) to a voltage (for example, 4.2 V) corresponding to a 100% state of charge (SOC100), discharge the battery cell to a voltage (for example, 2.5 V) corresponding to a 0% state of charge (SOC0), and charge the battery cell to a voltage corresponding to approximately 60% to 70% state of charge (SOC).

The pulse operation (S350) may include charging or discharging with a pulse current Pulse1 and/or Pulse2 during at least one of a period (including Pulse2 in FIG. 4) after the second charge-discharge operation (S320) and a period (including Pulse1 in FIG. 4) between the first charging operation (S310) and the second charge-discharge operation (S320). Accordingly, the polarization state and/or surface charge imbalance of the battery cell (10 in FIG. 3) immediately after the first charging operation (S310) may be quickly resolved, and the polarization state and/or surface charge imbalance of the battery cell (10 in FIG. 3) immediately after the second charge-discharge operation (S320) may be quickly resolved.

For example, the aging operation (S315 and/or S325) may include a first aging operation (S315) for aging the battery cell (10 in FIG. 3) between the first charging operation (S310) and the second charge-discharge operation (S320), and may include a second aging operation (S325) for aging the battery cell (10 in FIG. 3) after the second charge-discharge operation (S320). For example, a degassing process and a short rest may be performed between the first aging operation (S315) and the second aging operation (S325), and may remove gases (for example, gases resulting from electrical characteristic formation) within the battery cell (10 in FIG. 3) generated in the first aging operation (S315). For example, the short rest (Rest) may be implemented by not charging or discharging for a time period ranging from 1 minute or more to 5 minutes or less, and the time period is not limited.

The pulse operation (S350) may include charging or discharging with a pulse current Pulse1 and/or Pulse2 during at least one of the period (including Pulse1 in FIG. 4) between the first charging operation (S310) and the first aging operation (S315) and the period (including Pulse2 in FIG. 4) between the second charge-discharge operation (S320) and the second aging operation (S325). The pulse current during the period (including Pulse1 in FIG. 4) may shorten the time of the first aging operation (S315), and the pulse current during the period (including Pulse2 in FIG. 4) may shorten the time of the second aging operation (S325). For example, the total aging time of each of the first aging operation (S315) and the second aging operation (S325) may be, but is not limited to, 1 minute or more and 10 minutes or less.

For example, each of the first aging operation (S315) and the second aging operation (S325) may include high-temperature aging (HT-Aging2, HT-Aging3), which ages the battery cell 10 at a higher temperature (HT) than the temperature of the pulse operation (S350), and low-temperature aging (RT-Aging2, RT-Aging3), which ages the battery cell 10 at a lower temperature (RT) than the high temperature (HT). For example, the low temperature (RT) may be room temperature (for example, 15 to 30 degrees Celsius) or a temperature (for example, −10 to 10 degrees Celsius) lower than room temperature. For example, the high temperature (HT) may be a temperature (for example, 40 to 60 degrees Celsius) higher than room temperature, but is not limited thereto. While FIG. 4 illustrates that high-temperature aging (HT-Aging2, HT-Aging3) occurs before low-temperature aging (RT-Aging2, RT-Aging3), the order of high-temperature aging (HT-Aging2, HT-Aging3) and low-temperature aging (RT-Aging2, RT-Aging3) is not limited, and the number of cycles is not limited to 1 or 2.

The voltage measurement operation (S360) may include measuring the voltage OCV of the battery cell (10 in FIG. 3) from a time point (OCV2 in FIG. 4) between the second charge-discharge operation (S320) and the second aging operation (S325) to a time point (OCV3 in FIG. 4) after the second aging operation (S325). At this time (from OCV2 to OCV3), the voltage (OCV) pattern difference depending on whether a battery cell is defective may be relatively more apparent than at other times. Therefore, voltage data at this time (from OCV2 to OCV3) may be effective in detecting battery defects.

Referring to FIG. 3, a battery formation process system 100 according to an embodiment may include a charger-discharger 130 configured to charge or discharge a battery cell 10 that is to undergo the formation process, and a pulse generator 150 configured to generate pulses so that the current of the battery cell 10 is converted into a pulse current while the charger-discharger 130 is charging or discharging the battery cell 10. Accordingly, the total required time (for example, less than one day) for the formation process (S300 of FIG. 1) may be shortened, and the overall productivity of battery processes, including the formation process (S300 of FIG. 1), may be improved. For example, the time (for example, several days) for leaving the battery cell in a typical formation process may be omitted or reduced.

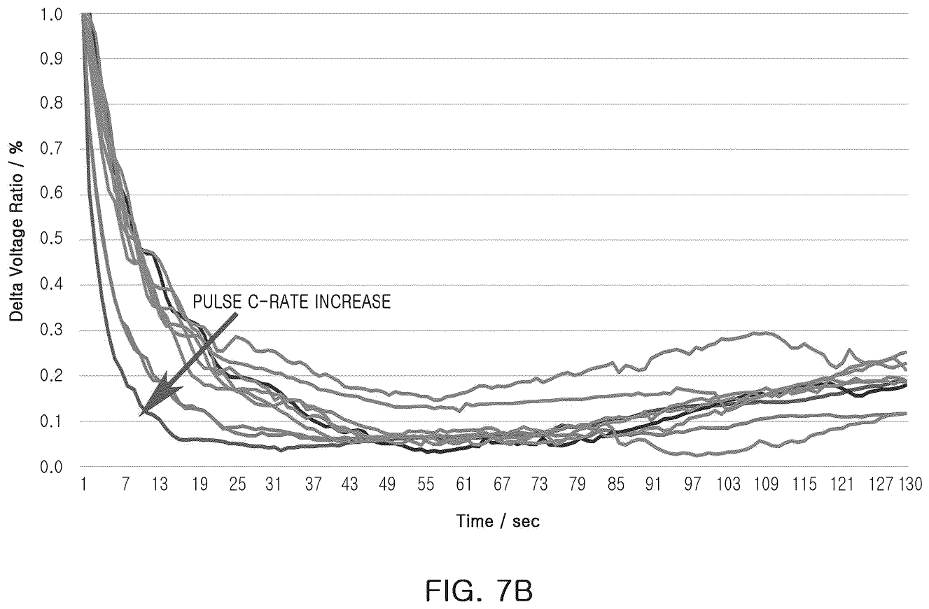

For example, the battery cell 10 may be formed by housing an electrode assembly composed of a cathode plate, an anode plate, and a separator in an outer case, injecting an electrolyte into the outer case, and then sealing the outer case. At this time, the electrodes 14 connected to the cathode plate and the anode plate, respectively, may be exposed to the outside of the outer case. The model (model, type) of the battery cell 10 is not particularly limited. For example, the shape (for example, pouch-shaped, prismatic, or cylindrical shape) or the material (for example, LFP (lithium iron phosphate), NCM (LiNiMnCoO2), mid-nickel (mid-Ni), high-nickel (high-Ni)) of the battery cell 10 is not particularly limited. Depending on the model (model, type) of the battery cell 10, the detailed data of the graphs of FIGS. 4, 7A, and 7B may vary.

For example, the charger-discharger 130 may include a circuit that converts commercial AC power into DC power, may include a circuit (for example, a regulation circuit, or a feedback circuit) that controls the magnitude of the current of the DC power, may include a power supply such as a switched mode power supply (SMPS), may include a circuit that controls whether the current of the DC power is output (for example, a triggering circuit), and may be electrically connected to the electrode 14 via a wire (for example, a power cable), but is not limited thereto.

Depending on the design, the pulse generator 150 may convert the charge/discharge current of the charger-discharger 130 into a pulse current, charge/discharge the battery cell 10 with a pulse current instead of the charger-discharger 130, or add a pulse current to the current of the charger-discharger 130. For example, the pulse generator 150 may include a circuit that generates pulse current, such as a switched mode power supply (SMPS), or may convert the current of the charger-discharger 130 into pulse current by switching the connection of a capacitor that smooths the current of the SMPS of the charger-discharger 130, but is not limited thereto.

Referring to FIG. 3, the battery formation process system 100 according to an embodiment may further include at least one of a measuring device 160, a controller 170, a temperature controller 140, and a pressurizer 120.

The measuring device 160 may be configured to measure the voltage OCV of the battery cell 10 from a point in time (for example, OCV2 in FIG. 4) after the pulse generator 150 generates the pulse. For example, the measuring device 160 may be implemented as a digital multimeter and may include an analog measuring circuit (for example, a sampling circuit, a buffer circuit, an amplifier circuit, or an analog-to-digital conversion circuit). For example, the measuring device 160 may include a sampling circuit that repeatedly samples the voltage of the battery cell 10 at short intervals, an envelope detection circuit that detects the trend of the voltage of the battery cell 10 by frequency analysis (or Fourier transform-based analysis), and a timer (which may be included in the controller 170) that counts time and generates a time value. For example, the measuring device 160 may assign a time value to each of the sampled voltages, and may determine whether the voltage of the battery cell is rising or falling based on the difference between the sampled voltages whose time values are adjacent to each other, and may also calculate the rising/falling speed (or slope). Depending on the design, the measuring device 160 may perform the above determination and/or calculation based solely on the sampling voltage within a predetermined time range among the time values of the sampling voltage.

The controller 170 may be configured to detect a defect (for example, a low voltage failure) in the battery cell 10 based on the difference between the pattern of voltage measured by the measuring device 160 and a reference pattern. Accordingly, the battery formation process system 100 not only shortens the total required time (for example, less than one day) for the formation process, but also provides data capable of detecting defects in the battery cell 10. Therefore, the process of leaving the battery cell 10 for an extended period of time (for example, several days) to detect defects in the battery cell may be omitted.

For example, the controller 170 may be implemented as a data acquisition system and may include a computing system (for example, a microcontroller, a programmable logic controller (PLC), an embedded system, or a manufacturing execution system (MES)). For example, the computing system may include a processor (for example, CPU, GPU), memory (for example, volatile memory, non-volatile memory), a recording medium, an input/output device, and a communication device. For example, the controller 170 may operate in a manner in which the processor executes one or more programs (and/or algorithms, logic) recorded in the memory or storage, and the operations may correspond to instructions of the program and may correspond to operations executed by the method of detecting a battery defect in the formation process according to an embodiment. For example, the controller 170 may store the reference pattern in the memory and analyze the pattern through the processor.

The temperature controller 140 may be configured to raise the temperature of the battery cell 10 during a portion (for example, HT-Aging3 in FIG. 4) of the time while the measuring device 160 measures the voltage OCV of the battery cell 10 (for example, from OCV2 to OCV3 in FIG. 4). The charger-discharger 130 may stop charging/discharging the battery cell 10 while the temperature controller 140 raises the temperature. Accordingly, the battery cell 10 that has been charged and discharged with a pulse current immediately before may be stabilized (for example, polarization resolved and surface charge imbalance resolved) more quickly. For example, the temperature controller 140 may be implemented to control a structure that heats or cools the chamber containing the battery cell 10 therein. Depending on the design, at least a portion (for example, temperature control logic, or the like) of the temperature controller 140 may be implemented as the controller 170.

The pressurizer 120 may pressurize the battery cell 10, and at this time, the charger-discharger 130 may charge the battery cell 10. For example, the pressurizer 120 may be at least a part of Press Pre-Charge (PPC) equipment. For example, the pressurizer 120 may include a plurality of support plates 121 and 122, and the battery cell 10 may be disposed between the plurality of support plates 121 and 122. At this time, the plurality of support plates 121 and 122 may pressurize the battery cell 10 by coming close to each other to press the battery cell 10 in the vertical direction.

For example, the charger-discharger 130 may pre-charge the battery cell 10 while the pressurizer 120 pressurizes the battery cell 10, and may perform formation charge or formation charge-discharge on the battery cell 10 while the pressurizer 120 is not pressurizing the battery cell 10. The measuring device 160 may measure the voltage of the battery cell 10 from a point in time (for example, OCV2 in FIG. 4) after formation charge or formation charge-discharge on the battery cell 10. The pulse generator 150 may generate pulses so that the current of the battery cell 10 is converted into a pulse current while the charger-discharger 130 performs at least one of a pre-charge, a formation charge, and formation charge-discharge of the battery cell 10. Accordingly, the polarization state and/or surface charge imbalance of the battery cell 10 immediately after at least one of formation charge and formation charge-discharge is performed may be quickly resolved.

The solid lines in FIGS. 5A, 5B and 5C represent the voltage of the battery cell, and the dotted lines in FIGS. 5A, 5B and 5C represent the maximum current of the battery cell. Referring to FIGS. 1, 3, 5A, 5B and 5C, the pulse operation (S350) may include discharging the battery cell 10 with the pulse current (charge/discharge switching in FIGS. 5A and 5B) if the battery cell 10 is in a charged state by the charge-discharge operation (S310 and/or S320), and charging the battery cell 10 with the pulse current (charge/discharge switching in FIG. 5C) if the battery cell 10 is in a discharged state by the charge-discharge operation (S310 and/or S320). The pulse generator 150 may generate pulses to discharge (the charge/discharge switching in FIGS. 5A and 5B) the battery cell 10 with a pulse current while the charger-discharger 130 is charging the battery cell 10, or to charge (the charge/discharge switching in FIG. 5C) the battery cell 10 with a pulse current while the charger-discharger 130 is discharging the battery cell 10.

Accordingly, the battery cell 10 may receive additional stimulation from the switching between charge and discharge when electrically stimulated by the pulse current in the pulse operation (S350), thereby enabling faster stabilization (for example, polarization relief, surface charge imbalance resolution).

The current during a portion of a unit cycle of the pulse currents Pulse1, Pulse2 and Pulse3 of the pulse operation (S350) may be greater than the currents CC1, CC2 and CC3 of the charge-discharge operation (S310 and/or S320). The current during a portion of a unit cycle of the pulse currents Pulse1, Pulse2 and Pulse3 may be greater than the current of the battery cell 10 before the pulse generator 150 generates the pulses.

Accordingly, the current during a portion of a unit cycle of the pulse currents Pulse1, Pulse2 and Pulse3 may momentarily provide a strong electrical stimulus to the battery cell (10 in FIG. 3), while the remaining portion of the unit cycle may be a period of electrical rest for the battery cell 10 so that the strong electrical stimulus does not cause damage to the battery cell 10. Therefore, the battery cell 10 after the pulse operation (S350) may be quickly stabilized. For example, the pulse current Pulse1 and/or Pulse2 may have a waveform in which a large current (for example, about twice the current (CC1, CC2, CC3)) and a small current (including 0 A) are periodically repeated, and the unit cycle may be a cycle including one large current and one small current.

For example, the voltage slope according to the pulse currents Pulse1, Pulse2 and Pulse3 may be steeper than a slope of voltages V1, V2 and V3 during the charge-discharge operation (S310 and/or S320), but is not limited thereto. The voltage slope may become steeper as the charge/discharge rate (C-rate) increases.

The total time for charging or discharging with the pulse current may be shorter than the total time for charging or discharging the battery cell 10 during the charge-discharge operation (S310 and/or S320). The total time for the pulse generator 150 to generate pulses may be shorter than the total time for the charger-discharger 130 to charge or discharge the battery cell 10 while the pulse generator 150 is not generating pulses. Accordingly, damage to the battery cell (10 in FIG. 3) may be reliably prevented even while the battery cell is electrically stimulated by pulse currents Pulse1, Pulse2 and Pulse3.

For example, the pulse operation (S350) may include charging or discharging with a pulse current at a charge/discharge rate (C-rate) of 0.5 C or more and 5.0 C or less for a total time of 1 second or more and 30 seconds or less. The pulse generator 150 may generate pulses so that the battery cell is charged or discharged with the pulse current at a charge/discharge rate (C-rate) of 0.5 C or more and 5.0 C or less for a total time of 1 second or more and 30 seconds or less.

Referring to FIGS. 1, 3, and 5B, the second charge-discharge operation (S320) may include charging, discharging and charging the battery cell 10, and the pulse operation (S350) may include discharging with a pulse current Pulse2. For example, the pulse operation (S350) may include a charge/discharge switching.

Referring to FIGS. 1, 3, and 5C, the second charge-discharge operation (S320) may include charging and discharging the battery cell 10, and the pulse operation (S350) may include charging with a pulse current Pulse3. For example, the pulse operation (S350) may include a charge/discharge switching.

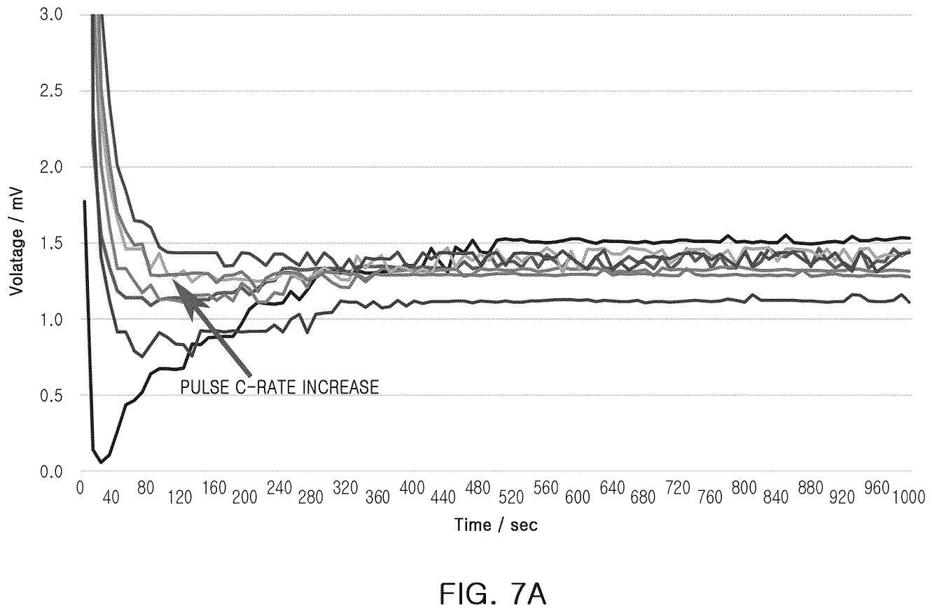

Referring to FIG. 6, the anode of the electrode 14 may include an anode material 14g and a current collector 14c. For example, the anode material 14g may be composed of graphite and/or silicon (Si), and the current collector 14c may be composed of copper (Cu). The anode material 14g may include a solid electrolyte interphase (SEI) formed on the surface thereof. During charging and discharging of the electrode 14, lithium ions (LI) may migrate into and out of the anode material 14g through electrochemical reactions (for example, ion intercalation) in the solid electrolyte interphase (SEI).

In a battery cell 10-1 immediately after charging (and/or discharging), lithium ions (LI) may polarize. Subsequently, in a battery cell 10-2 being discharged (and/or charged) with a pulse current, the lithium ion (LI) polarization may be forcibly relaxed for a short period of time (for example, approximately 10 seconds). A battery cell 10-3 immediately after being discharged (and/or charged) with a pulse current may be stabilized into a battery cell 10-4 in which the lithium ion (LI) polarization has been resolved.

FIG. 7A shows the results of measuring the voltage OCV of a battery cell starting from OCV2 of FIG. 4 (omitting the aging operation), and is a graph in which the lowest voltage among the voltage data in FIG. 7A is set to 0 mV. The multiple curves in FIG. 7A represent voltage patterns resulting from discharging with pulse currents at different charge/discharge rates (C-rates). FIG. 7B is a graph representing the rate of change (Delta Voltage Ratio) of the voltage data in FIG. 7A as a percentage (%).

Referring to FIGS. 7A and 7B, as the charge/discharge rate (C-rate) of the pulse current Pulse becomes faster, the undershoot of the initial voltage data may be reduced, and the change rate (Delta Voltage Ratio) of the initial voltage data may be lowered more quickly. The less the undershoot or the lower the change rate (Delta Voltage Ratio), the faster the stabilization speed of the battery cell may be. The faster the charge/discharge rate (C-rate) of the pulse current Pulse, the greater the influence of the battery cell may be caused by the pulse current Pulse. Ultimately, the pulse current Pulse may accelerate the stabilization speed of the battery cell.

As set forth above, a method of stabilizing a battery in a formation process and a battery formation process system according to an embodiment may shorten the total required time (for example, to less than one day) for the formation process and improve the overall productivity of battery processes, including the formation process. For example, the time (for example, several days) required for battery cells to be left in a formation process of the related art may be omitted or reduced.

Furthermore, the method of stabilizing a battery in a formation process and the battery formation process system not only shorten the total required time for the formation process but also provide data for detecting battery cell defects. Therefore, the process of leaving battery cells in the formation process for an extended period (for example, several days) to detect battery cell defects may be omitted.

Only specific examples of implementations of certain embodiments are described. Variations, improvements and enhancements of the disclosed embodiments and other embodiments may be made based on the disclosure of this patent document.

What is claimed is:

1. A method of stabilizing a battery in a formation process, comprising:
a charge-discharge operation of charging or discharging a battery cell in a formation process; and
a pulse operation of charging or discharging the battery cell with a pulse current having a greater fluctuation than a current of the charge-discharge operation after the charge-discharge operation.

2. The method of claim 1, wherein the charge-discharge operation includes,
a first charging operation of performing a press pre-charge (PPC) or a pre-charge on the battery cell; and
a second charge-discharge operation of performing a formation charge or a formation charge-discharge on the battery cell after the first charging operation,
wherein the pulse operation includes charging or discharging with the pulse current during at least one of a period after the second charge-discharge operation or a period between the first charging operation and the second charge-discharge operation.

3. The method of claim 2, wherein the second charge-discharge operation includes charging and discharging the battery cell, and
the pulse operation includes charging with the pulse current.

4. The method of claim 2, wherein the second charge-discharge operation includes charging, discharging, and recharging the battery cell, and
the pulse operation includes discharging with the pulse current.

5. The method of claim 2, further comprising:
an aging operation aging the battery cell,
wherein the aging operation includes,
a first aging operation of aging the battery cell between the first charging operation and the second charge-discharge operation; and
a second aging operation of aging the battery cell after the second charge-discharge operation,
wherein the pulse operation includes charging or discharging with the pulse current during at least one of a period between the first charging operation and the first aging operation or a period between the second charge-discharge operation and the second aging operation.

6. The method of claim 5, wherein each of the first aging operation and the second aging operation includes high-temperature aging for aging the battery cell at a higher temperature than a temperature of the pulse operation; and low-temperature aging for aging the battery cell at a lower temperature than the high temperature.

7. The method of claim 5, wherein a total aging time of each of the first aging operation and the second aging operation is 1 minute or more and 10 minutes or less.

8. The method of claim 5, further comprising:
a voltage measurement operation of measuring voltage of the battery cell from a time point between the second charge-discharge operation and the second aging operation to a time point after the second aging operation, and
a defect detection operation of detecting a defect in the battery cell based on a difference between a pattern of the voltage measured in the voltage measurement operation and a reference pattern.

9. The method of claim 1, further comprising:
an aging operation aging the battery cell after the pulse operation.

10. The method of claim 9, further comprising:
a voltage measurement operation of measuring voltage of the battery cell from a time point between the pulse operation and the aging operation to a time point after the aging operation; and
a defect detection operation of detecting a defect in the battery cell based on a difference between a pattern of the voltage measured in the voltage measurement operation and a reference pattern.

11. The method of claim 9, wherein the pulse operation includes discharging the battery cell with the pulse current when the battery cell is in a charged state by the charge-discharge operation, and charging the battery cell with the pulse current when the battery cell is in a discharged state by the charge-discharge operation.

12. The method of claim 1, wherein the charge-discharge operation includes charging the battery cell with a constant current having less fluctuation than the pulse current for at least a portion of time of the charge-discharge operation.

13. The method of claim 1, wherein a current during a portion of a unit cycle of the pulse current is greater than a current during the charge-discharge operation, and
a total time for charging or discharging with the pulse current is shorter than a total time for charging or discharging the battery cell during the charge-discharge operation.

14. The method of claim 1, wherein the pulse operation includes charging or discharging with the pulse current at a charge/discharge rate (C-rate) of 0.5 C or more and 5.0 C or less for a total time of 1 second or more and 30 seconds or less.

15. A battery formation process system comprising:
a charger-discharger configured to charge or discharge a battery cell to be subjected to a formation process; and
a pulse generator configured to generate a pulse such that current of the battery cell is converted into a pulse current while the charger-discharger is charging or discharging the battery cell.

16. The battery formation process system of claim 15, further comprising:
a measuring device configured to measure voltage of the battery cell from a time point after the pulse generator generates the pulse; and
a controller configured to detect a defect in the battery cell based on a difference between a pattern of the voltage measured by the measuring device and a reference pattern.

17. The battery formation process system of claim 16, further comprising a temperature controller configured to raise temperature of the battery cell during a portion of time while the measuring device measures the voltage of the battery cell,
wherein the charger-discharger stops charging or discharging the battery cell while the temperature controller raises the temperature.

18. The battery formation process system of claim 17, further comprising a pressurizer applying pressure to the battery cell,
wherein the charger-discharger pre-charges the battery cell while the pressurizer applies the pressure to the battery cell, and performs a formation charge or a formation charge-discharge on the battery cell while the pressurizer is releasing pressure to the battery cell,
the measuring device measures voltage of the battery cell from a point in time after the formation charge or the formation charge-discharge on the battery cell, and
the pulse generator generates a pulse so that the current of the battery cell is converted into the pulse current while the charger-discharger performs at least one of pre-charge, the formation charge, or the formation charge-discharge on the battery cell.

19. The battery formation process system of claim 15, wherein the pulse generator generates a pulse so that the battery cell is discharged with the pulse current while the charger-discharger charges the battery cell, or generates a pulse so that the battery cell is charged with the pulse current while the charger-discharger discharges the battery cell.

20. The battery formation process system of claim 15, wherein a current during a portion of a unit cycle of the pulse current is greater than the current of the battery cell before the pulse generator generates the pulse,
a total time for which the pulse generator generates the pulse is shorter than a total time for which the charger-discharger charges or discharges the battery cell while the pulse generator is not generating the pulse, and
the pulse generator generates a pulse so that the battery cell is charged or discharged with the pulse current at a charge/discharge rate (C-rate) of 0.5 C or more and 5.0 C or less for a total time of 1 second or more and 30 seconds or less.
